(19) United States
(12) Patent Application Publication
(10) Pub. No.: US 2010/0070748 A1
(43) Pub. Date: Mar. 18, 2010

(54) Device and methods for simulating controller area network signals

(75) Inventors: Huihui Duan, New Bedford, MA (US); Chaonan Chen, New Bedford, MA (US); Mingming Duan, Spartanburg, SC (US)

Correspondence Address: Huihui Duan, Unit #20, 3299 Acushnet Ave, New Bedford, MA, 02745, US

(73) Assignee: Au Group Electronics, New Bedford, MA (US)

(21) Appl. No.: 12/283,795

(22) Filed: Sep. 17, 2008

(51) Int. Cl. H04L 9/32; G06F 17/10; H04L 9/08; G06F 15/177; G09F 9/33

(52) U.S. Cl. 713/2; 703/2; 726/18; 713/157; 340/815.45

(57) ABSTRACT

The invention relates to a device of generating simulation signals for Controller Area Network (CAN). The device in this invention simulates CAN data streams normally generated by electronic control units (ECUs) in automobiles, vehicles, boats, etc. without the presence of these ECUs. The device in this invention has a visual display of simulated signals' values. In addition, this invention reveals a remote terminal method and software. The remote terminal software in this invention can control the simulated signal via graphic user interfaces. The remote terminal software in this invention also displays the precise values of simulated signals via graphic user interfaces. Furthermore, this invention presents an advantageous method using a license identification management technique to change the functionality and features of the simulation device without any hardware modifications and without sending the device back to the device manufacturer.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### REFERENCES CITED-PUBLICATIONS

1. <http://en.wikipedia.org/wiki/Controller_Area_Network>—“Controller-area Network, From Wikipedia, the free encyclopedia”.
2. <http://en.wikipedia.org/wiki/Controller_Area_Network>—“Controller-area Network, Standards”.
3. <http://www.auelectronics.com/UserManual.htm>—“User Manual for SAE-J1939 Simulator (Gen II)”, Copyright 2008 Au Group Electronics.
4. <http://www.auelectronics.com/UserManual.htm>—“License Management User Manual for SAE-J1939 Simulator”, Copyright 2008 Au Group Electronics.
5. <http://www.auelectronics.com/UserManual.htm>—“AU SAE-J1939 Simulator Remote Terminal Installation Guide”, Copyright 2008 Au Group Electronics.
6. <http://www.auelectronics.com/UserManual.htm>—“Au PIC Bootloader (Application Note)”, Copyright 2008 Au Group Electronics.

### FIELD OF THE INVENTION

This invention relates generally to a device of generating simulated Controller Area Network (CAN) signals such as those from electronic control units (ECUs) in automobiles, on-highway vehicles, boats, etc without the presence of these ECUs. This invention includes a remote terminal method and software which are capable of controlling the simulation and displaying the precise values of simulated signals. This invention also relates to an advantageous method to change the functionality and features of the simulation device without any hardware modifications and without sending the device back to the device manufacturer.

### BACKGROUND

According to Reference 1, the definition of Controller Area Network (CAN) is: “Controller-area network (CAN or CAN-bus) is a computer network protocol and bus standard designed to allow microcontrollers and devices to communicate with each other without a host computer.” It was originally developed by Robert Bosch GmbH and designed specifically for networking most of the distributed electrical devices throughout an automobile. CAN is an extremely robust protocol with extensive error detection and correction features which easily withstand the harsh physical and electrical environment presented by an automobile, a vehicle, a boat and other industry environment. Critical devices in a vehicle such as the electronic control unit (ECU) of an engine, antilock brakes, airbags, etc rely on the Controller Area Network. Due to the low cost of CAN controllers and processors, today the Controller Area Network has been widely used in automotives, agriculture tractors, on-highway trucks, heavy duty vehicles, marine electronic devices, boats, airborne applications, embedded systems, real time distributed control (fieldbus) in general automation environments, assembly, material handling, packaging and high-speed sortation machines.

In order to develop, test and diagnose the CAN applications devices, full range CAN signals are needed. These signals are normally generated by actual systems, such as a test-dedicated automobile ECU, etc. However actual systems can not always easily produce a full range CAN signals due to the physical and functionality limits of the actual system. For example, in order to do a full range test for a speedometer of maximum limit of 155 miles-per-hour, the test person must be able to drive the vehicle at 155 miles per hour. This is sometimes hard to achieve and maintain. In another example, if one wants to test the error condition of an antilock braking system in a heavy duty truck, one needs to generate error signals in the vehicle, which is not easily achieved in the field.

During the development stages of a CAN applications device, the requirements of CAN signals often change. This sometimes requires a more complicated actual system to generate new CAN signals. Meeting this requirement can be costly. In other cases, it is desirable to have multiple types of CAN signals for the test purpose. This will require multiple actual systems. For example, an instrument cluster development project requires signals from an engine, signals from a transmission system, signals from a brake system, signals from a pressure sensor module, signals from switch modules, and signals from actuator modules, etc. This means the project team will need an engine and its ECU, a transmission system and its ECU, a brake system and its ECU, a pressure sensor module and its ECU, switch modules and their ECUs, actuator modules and their ECUs, etc. The size and cost of such a large pool of test equipments can become very challenging. Also in this case, due to the fact of using multiple actual ECUs, controlling all of the actual systems at the same time or reading/visualizing the signals from all of the systems at the same time is difficult for the testing operator(s).

In other situations, supplying CAN signals can be destructive to the actual system or time-consuming or imposing a lot of environmental hazards. For example, in order to test the over-limit protection feature on the transmission system, one has to operate the vehicle over the limit of transmission. It may become destructive to the transmission. In another example, if one needs make full range testing for a vehicle odometer, the process to obtain the high mileages by driving a vehicle with the odometer on board would have imposed a great amount of emissions to the environment, let alone the process is time consuming and costly.

### SUMMARY OF THE INVENTION

It is therefore one aspect of this invention to provide a device to generate a CAN signal for its full range and to generate a CAN signal that is hard-to-achieve in the field by an actual system.

It is therefore the second aspect of this invention to provide a device to generate new types of CAN signal relatively easily, and to generate multiple types of CAN signals at the same time.

It is therefore the third aspect of this invention to provide a signal generating device with an easy-to-use feature and an easy-to-read/visualize feature for the CAN signals generated by the device.

It is therefore the fourth aspect of this invention to provide a signal generating device that the signal generating process is not destructive to actual systems, not time-consuming and is barely environmental hazardous.

In accordance with these aspects of the invention, a device for generating Controller Area Network simulation signals is provided. The use of such a simulating device provides a new approach for generating CAN signals. The use of such a simulating device enables the user's access to the signals that are hard-to-achieve by an actual system in the filed. This invention uses an advantageous algorithm to focus the simulation signals within the mostly used ranges, yet the algorithm still covers the minimum and maximum limits of the CAN signals as defined by different industry protocols. So it can be used to generate a CAN signal for its full range.

In this invention, a method of device license identification management system is provided. With this method, the simulation device can be easily upgraded or downgraded to include more or less functions of signal simulation without the need to purchase a new device, without the need of sending the device back to the manufacturer, without the need of any hardware changes, without the need of even opening the enclosure of the device; instead it requires only changing the device license identification through a license identification management system. Therefore, such a signal generating apparatus is able to relatively easily and inexpensively generate new types of CAN signals, and to generate multiple types CAN signals at the same time.

This device of invention has the plug-and-play feature. No complex installation of hardware is required. The operation of such a device is through operating a push button or similar human machine interface media, or through making commands and selections on a graphic user interface software provided by the remote terminal method and software of this invention. The simulation device itself has a visual display to indicate the values of simulated signals, and it is also capable of producing audible sounds reflecting inputs from human machine interfaces. In addition, the remote terminal of this invention provides a visual access for the signal simulation control and displays precise values of those simulated signals. Therefore, the device has the aspect of easy-to-read/visualize for the CAN signals generated by the device. A method of using the license identification management system in this invention makes it possible for easily changing the functionality and features without any hardware change, without sending the device to the manufacturer, and without even opening the enclosure of the device. The device has an in-field bootloading feature. The bootloading feature makes it easy to refresh the simulation device if errors are found in programming codes. Also, the bootloading feature is very valuable and convenient to add newly released features and functions. All of these aspects combined fulfill the ease-of-use goal of the invention.

The device is powered by a 12-24 volts power supply; it can be made to occupy very little space in the common CAN application environment and to be so small to fit an adult size palm; it does not need any fuel or water; it does not generate harmful emission by itself; it does not require any maintenance when it is not in use; to generate CAN signals, it does not require a person to operate a real vehicle, a boat, a car, etc. Therefore it is not destructive to an actual system; generating signals by this device is not time-consuming or labor-consuming and the device reduces environmental hazards that might be otherwise produced by actual systems.

Further areas of applicability of the present invention will become apparent from the detailed description provided hereinafter. While the invention is susceptible to various modifications and alternative forms, specific embodiments thereof are shown by way of example in the drawings and are herein described in detail. It should be understood, however, that the drawing are detailed description thereto are not intended to limit the invention to the particular form disclosed, but on the contrary, the intention is to cover all modifications, equivalents and alternatives falling within the spirit and scope of the present invention as defined by the appended claims.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram of key components of a simulation signal generating device for Controller Area Network.

FIG. 2 illustrates that the invention's simulation signal generating device is connected with a Controller Area Network (CAN).

FIG. 3 represents three automatic functions of a signal simulation device when it is powered on.

FIG. 4 is a block diagram representing a remote terminal method and software and showing that a remote terminal in this invention is connected with a simulation signal generating device.

FIG. 5A depicts a graphic user interface of the control panel of a remote terminal.

FIG. 5B depicts a graphic user interface of the display panel of a remote terminal.

FIG. 5C depicts a graphic user interface of the communication selection port of a remote terminal.

FIG. 6A-E illustrates the license identification management method for a signal simulation device.

FIG. 7 illustrates linear algorithms between simulation steps and simulation values for Controller Area Network applications.

FIG. 8 illustrates non-linear algorithms and linear algorithms between simulation steps and simulation values for Controller Area Network applications.

FIG. 9A and FIG. 9B depict two working modes of the simulation signal generating device.

FIG. 10A-B illustrate exemplary enclosures, shapes and configurations of a signal simulation device and FIG. 10C illustrates the device software toolsets.

FIG. 11A-J represents simulation signal levels by the condition of a series of LEDs and the-likes from the simulation device.

FIG. 12 illustrates the flow chart of changing functionality and features for a simulation device by the license identification management systems.

### DETAILED DESCRIPTION OF THE INVENTION

The following established physical layer standards are for Controller Area Network. They are cited in this invention's specification. According to Reference 2, various CAN standards include:
SAE J1939 standard uses a two-wire twisted pair; SAE J1939-11 has a shield around the pair while SAE J1939-15 does not. SAE 1939 is widely used in agricultural & construction equipment.
ISO 11898-1 includes protocols of Controller Area Network data link layer and physical signaling.
ISO 11898-2 uses a two-wire balanced signaling scheme. It is the most used physical layer in car powertrain applications and industrial control networks.
ISO 11898-3 includes protocols of Controller Area Network low-speed, fault-tolerant, medium-dependent interface.
ISO 11898-4 standard defines the time-triggered communication on CAN (TTCAN). It is based on the CAN data link layer protocol providing a system clock for the scheduling of messages.
ISO 11898-5 includes protocols of Controller Area Network high-speed medium access unit with low-power mode.
ISO 11992-1 defines a Controller Area Network fault-tolerant for truck/trailer communication.
ISO 11783: It is intended for agriculture and forestry equipment.

SAE J2411 defines a single-wire Controller Area Network (“Single-wire CAN” has the abbreviation of “SWC”).

At the higher level of application layer protocols, the following protocols are developed and used in the various industries:

NMEA 2000 (National Marine Electronics Association 2000) is a combined electrical and data specification for a marine data network for communication between marine electronic devices.

DeviceNet is a communication protocol used in the automation industry to interconnect control devices for data exchange. It uses Controller Area Network as the backbone technology and defines an application layer to cover a range of device profiles.

CANopen is a communication protocol and device profile specification for embedded systems and used in automation.

J1939 is the vehicle bus standard used for communication and diagnostics among vehicle components, originally by the car and heavy duty truck industry in the United States.

CAN Kingdom is a communications protocol running on top of Controller Area Network; it is designed as fieldbus, a family of industrial computer network protocols used for real-time distributed control. The SmartCraft® network is a marine version of CAN Kingdom.

SafetyBUS p is a standard for safe field bus communication within factory automation.

MilCAN is a deterministic protocol that can be applied to Controller Area Network technology as specified by ISO 11898.

CANaerospace is an extremely lightweight protocol/data format definition which was designed for the highly reliable communication of microcomputer-based systems in airborne applications via Controller Area Network (CAN).

Smart Distributed System (SDS) is based on Controller Area Network technology and borrowed from the automotive industry and the RS485 electrical specification. It is commonly found in assembly, material handling, packaging and high-speed sortation machines.

An ARINC technical working group develops the ARINC 825 standard with special requirements for the aviation industry.

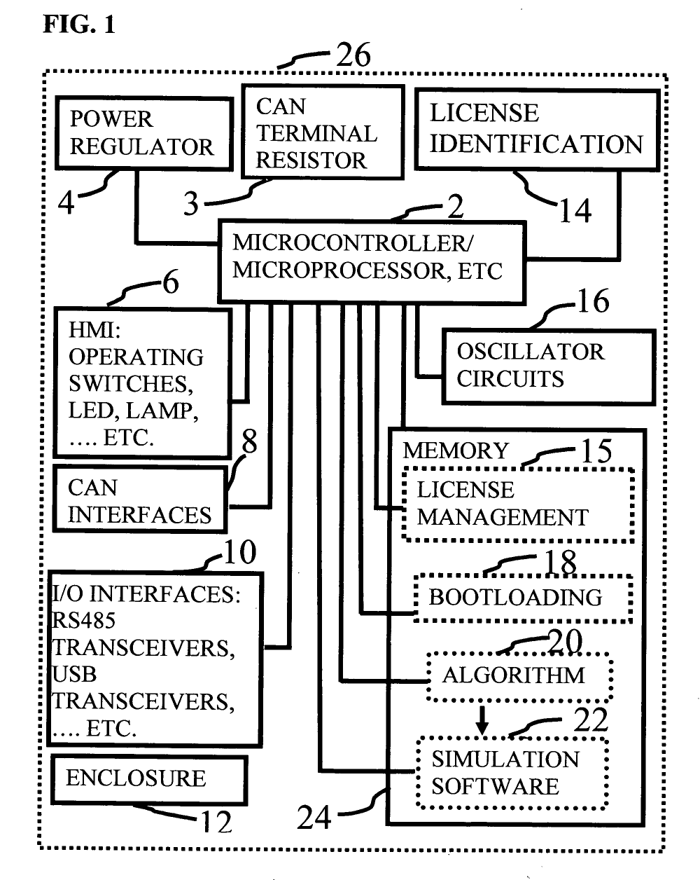

Referring now to the drawings, FIG. 1 is a block diagram of key components of a simulation signal generating device 26 for Controller Area Network 28 (CAN). It is a self-maintaining simulation signal generating device for CAN. It includes a microprocessor 2. In various embodiments, the microprocessor 2 may be a microcontroller, or a field-programmable gate array (FPGA), or an application-specific integrated circuit (ASIC), or a complex programmable logic device (CPLD). The simulation device includes a power regulator 4 converting an unregulated power supply to a regulated power supply with stable voltage. For example, when the device is using a battery power supply, the power regulator 4 will convert the power supply to a stable voltage supply for the simulation device. The device also has one or more of the commonly used input and output components 10, including but not limited to USB transceivers, RS485 transceivers, RS232 transceivers, SAE J1708 transceivers, etc. In order to communicate to a CAN network, this device comprises CAN interfaces 8, such as CAN transceivers (J1939 transceivers, NMEA 2000 transceivers, single wire CAN transceivers, etc), common mode chokes, CAN network terminal resistors 3 and signal isolation circuits (such as opto-isolators), etc. The device has oscillator circuits 16 providing clock signals for microcontroller and peripheral devices.

The simulation device includes a human machine interface (HMI) 6, including but not limited to operating switches, LEDs (light-emitting diodes), lamps, other audible or visible signal components. The human machine interface (HMI) 6 is expandable to one or multiple HMI (HMI), such as a display terminal for the simulated parameters, or multiple display terminals for the simulated parameters.

There is a memory medium 24 in the simulation device 26. The memory 24 is coupled to the microprocessor 2 or its equivalent. The memory medium 24 comprises a non-volatile memory, such as an EEPROM, a flash memory, a battery-backed RAM, etc, that stores initialization instructions and executable codes. Inside the memory, simulation software 22, license management system 15, bootloading software 18, etc are stored. The simulation software 22 is based on some simulation algorithms 20 defining and generating Controller Area Network simulation signals. For any particular Controller Area Network signal, the algorithm 20 defines the simulation algorithm according to the practical usage conditions in multiple segments over the full range, the full range, or partially over the full range of Controller Area Network signal. The full range of a CAN signal is defined by a CAN protocol or multiple CAN protocols of the following, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

The simulation device also has the license identification 14. The license identification 14 defines the functionality and features of the device in this invention.

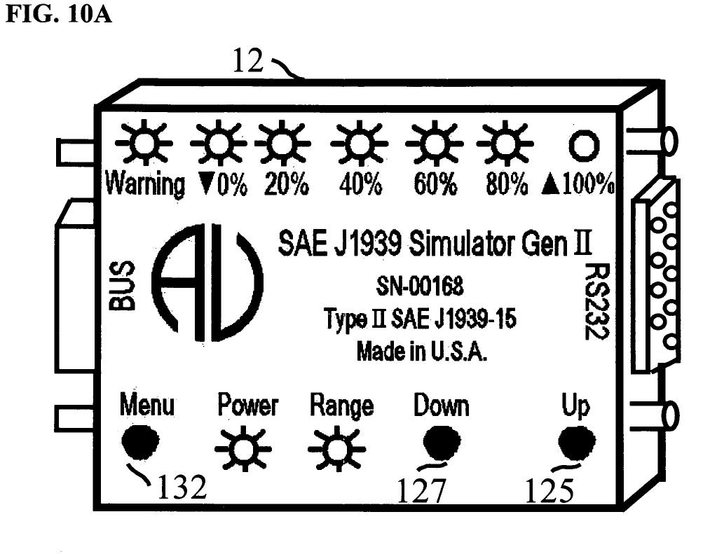

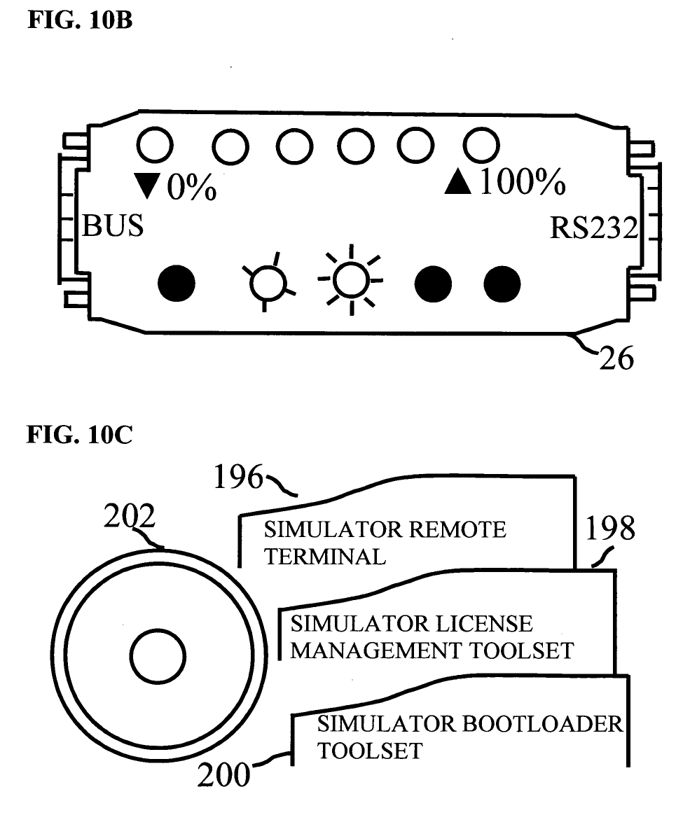

The simulation device 26 has an in-field bootloading feature 18 which enables the loading initialization instructions and executable codes to the device without opening the enclosure 12 and without sending the device back to a device service center or the manufacturer. This bootloading feature can be encrypted. The bootloading feature makes it easy to refresh the simulation device if errors are found in programming codes. Also, the bootloading feature is very valuable and convenient to add newly released features and functions. The bootloading 18 function can be enabled by pressing the MENU button 132 (FIG. 10A) in the human machine interface of the simulation device 26. After entering the bootloading mode, the simulation device 26 will automatically detect any pre-defined bootloading handshaking protocols. If it does not detect any bootloading handshaking protocols within a reasonable pre-set time, such as 10 seconds, the simulation device 26 will automatically exit the bootloading mode. Therefore the device tolerates any accidental or unintentional entry of bootloading mode by a user, and it will return to the normal operating mode.

The simulation software 22 executes the signal generating algorithm 20 and the I/O control algorithm for the simulation signals; it also controls the simulation process; it communicates with remote terminal 30; it generates and resets warning messages; and it manages the device license identification 14.

The simulation signals' values are modified through an operating switch or multiple operating switches 6 by the user per the predetermined operating switch combinations in the software of the simulation signal generating device 26.

The simulation device 26 has an enclosure 12. The enclosure 12 can be compliable to NMEA (National Marine Electronics Association) environment standard or it may not be compliable to that standard. In various embodiments, the enclosure 12 of the simulation device 26 can be configured as FIG. 10A. In one of various embodiments, FIG. 10B illustrates a simulation device 26 configured in a rectangular enclosure with different aspect ratio compared with FIG. 10A.

In one of various embodiments, the device can be made to fit a palm of an average size adult. Therefore it is convenient to carry around and easy to use. In various embodiments, the device size and enclosure configuration can be made appropriate to fit in various CAN application environments. In various embodiments, the size and configuration of the same or similar CAN signal simulation device can be changed and configured such that it can be placed at and transferred among various engineering testing environments, CAN network test laboratories, CAN application fields, etc.

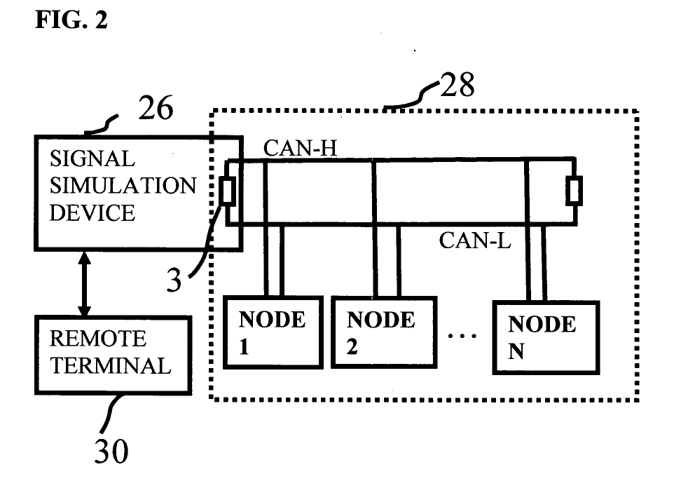

FIG. 2 illustrates that the invention's simulation signal generating device 26 is connected with a Controller Area Network (CAN) 28 via the CAN network terminal resistor 3 built inside the simulation device. The device may connect with a remote terminal 30, which expands the control and display functions of the simulation device 26.

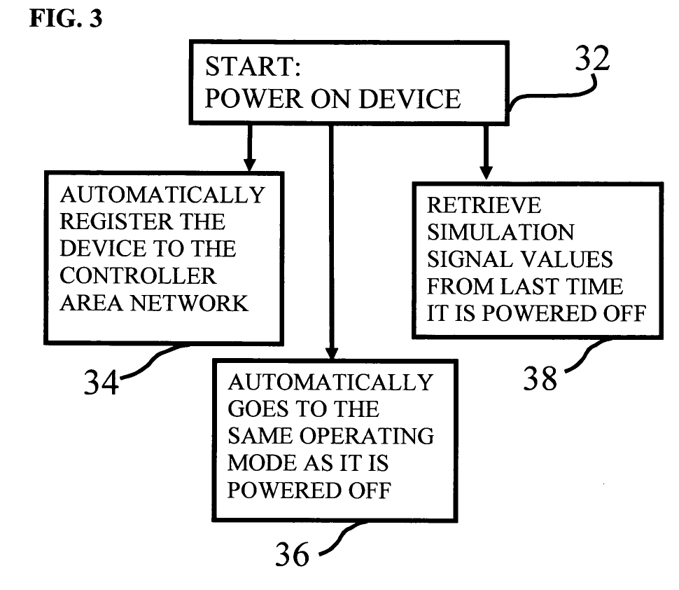

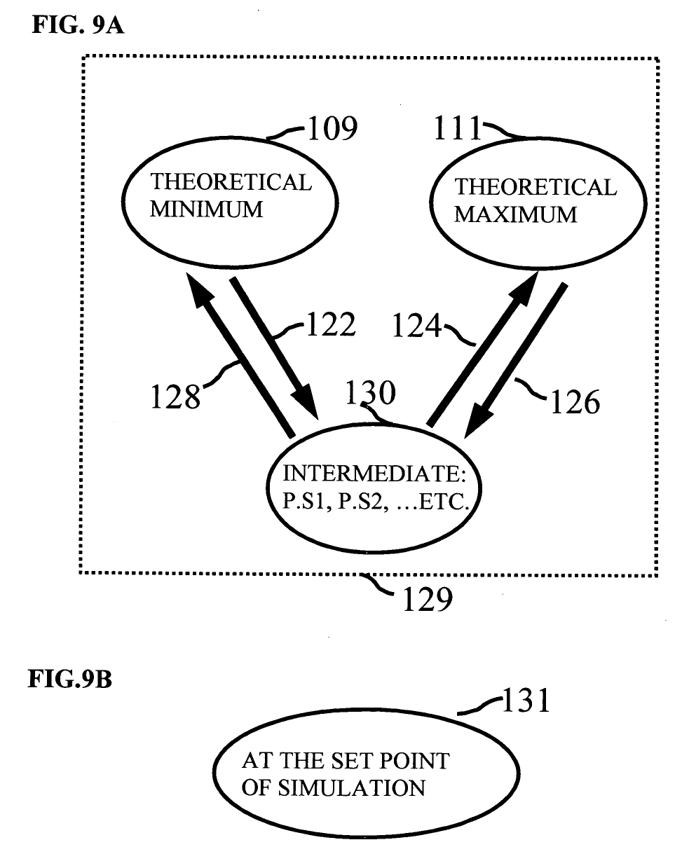

FIG. 3 illustrates what will happen on a CAN signal simulation device 26 when it is powered on. The device 26 will perform three automatic functions 34, 36, 38. It will automatically register itself to the Controller Area Network 28 (function 34). It will automatically go to the same operating mode (dynamic mode or static mode, which are depicted in FIG. 9A and FIG. 9B respectively) as it is powered off last time (function 36). In addition, the device 26 will retrieve the same simulation signal values as it is powered off last time (function 38).

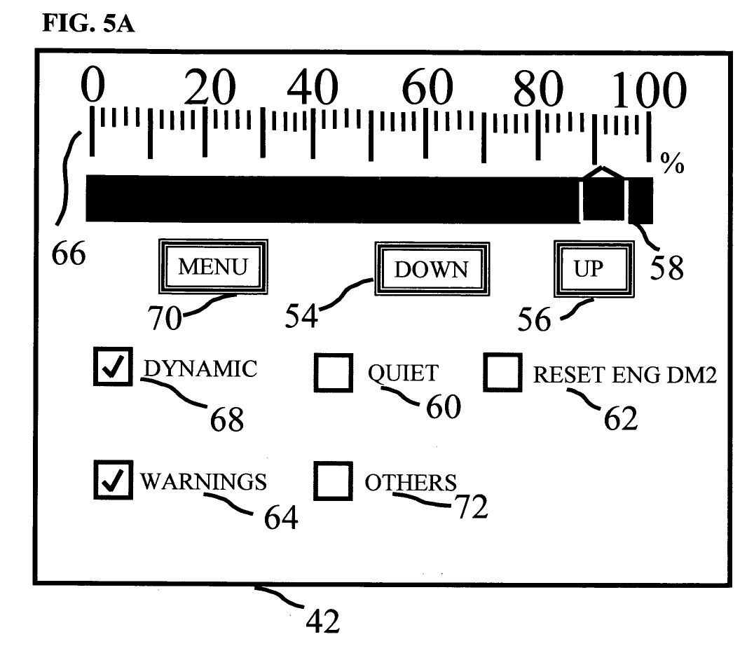

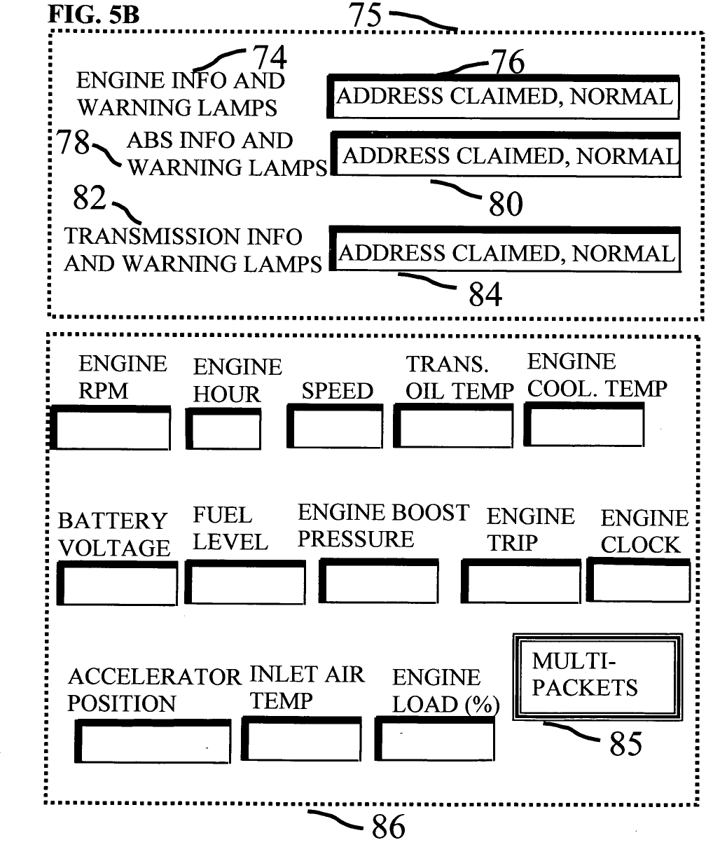

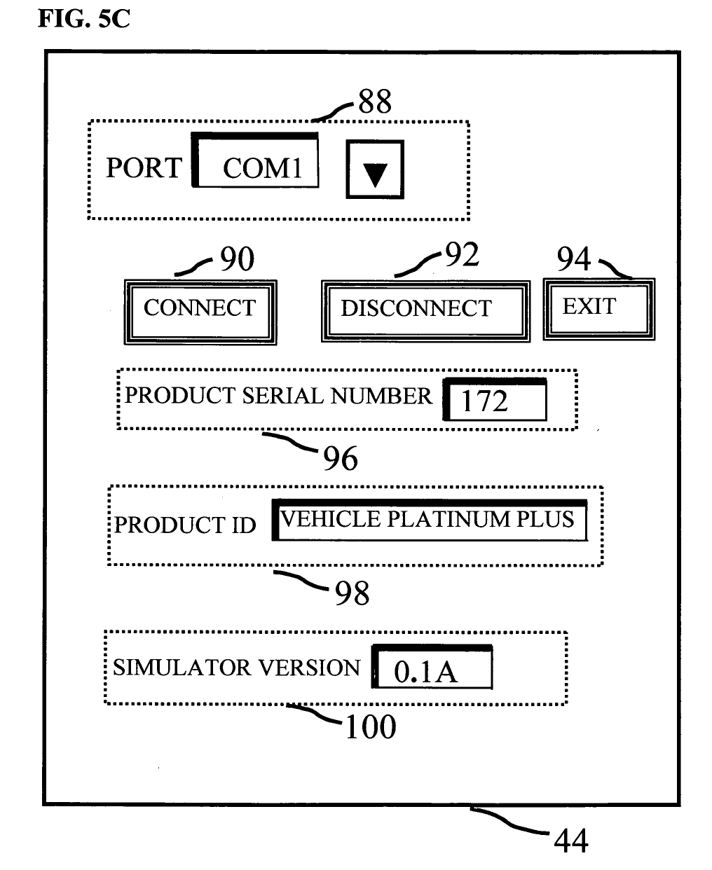

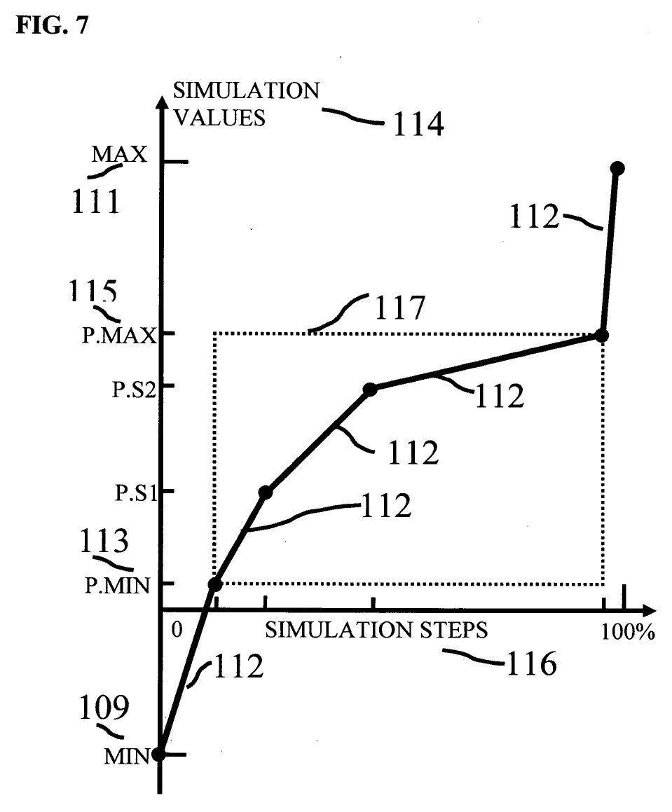

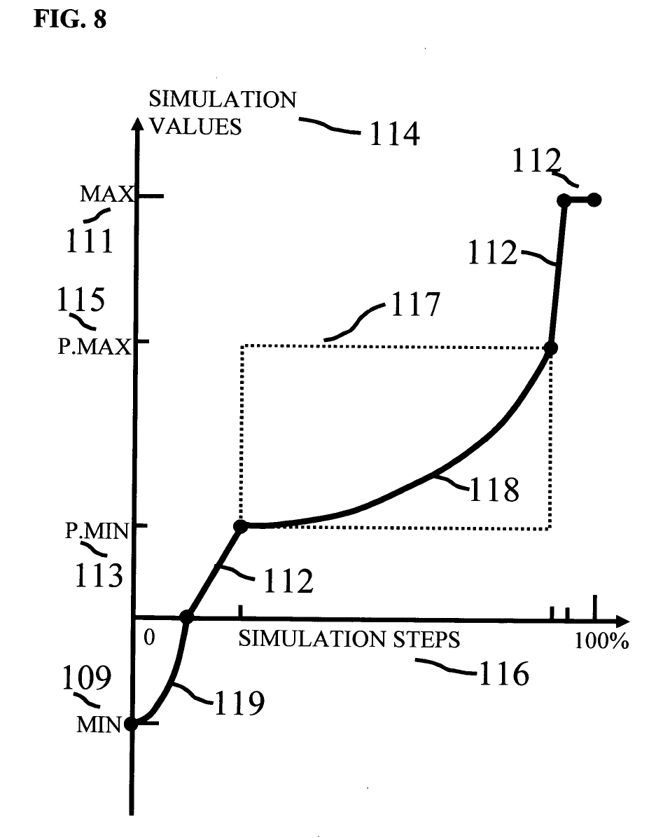

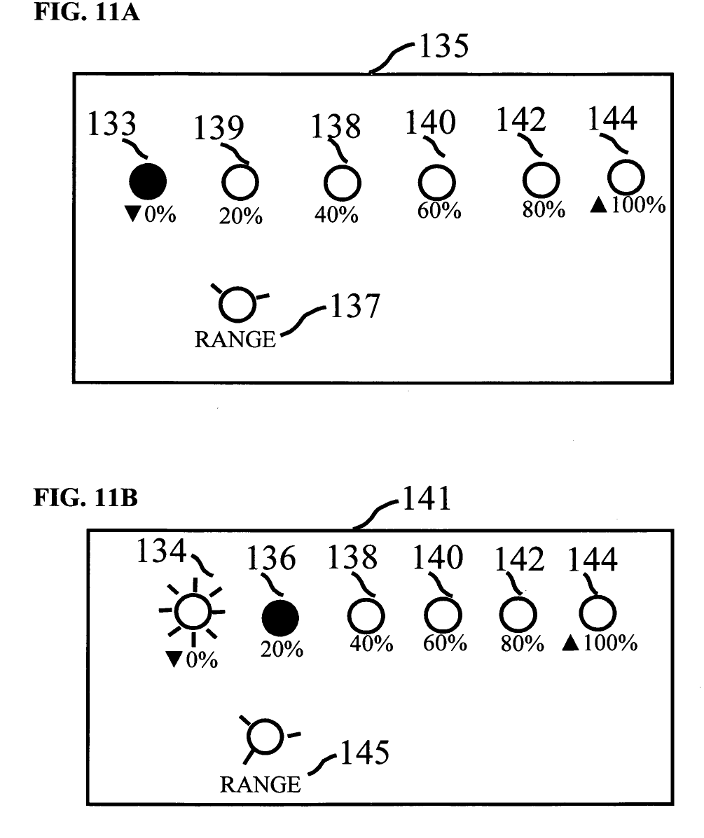

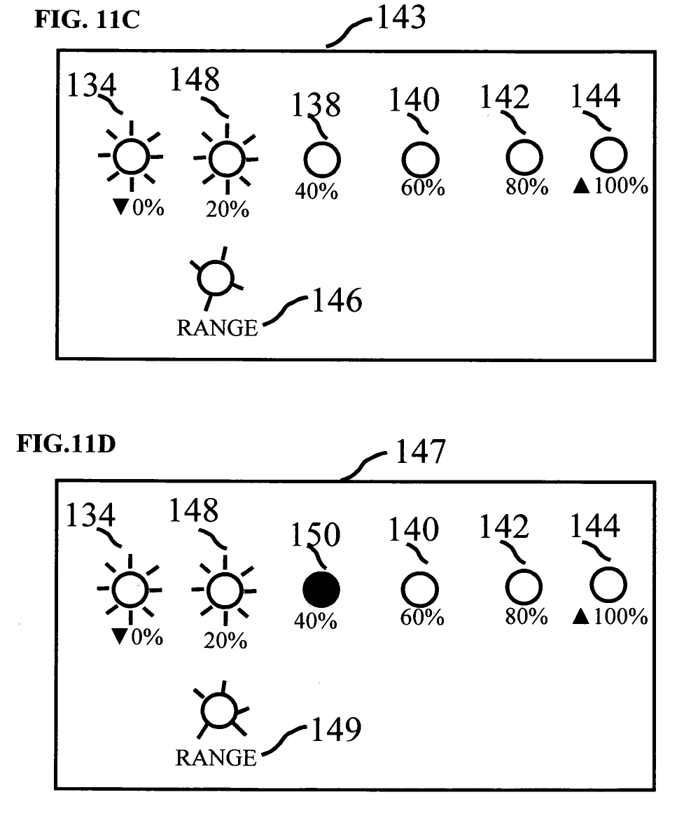

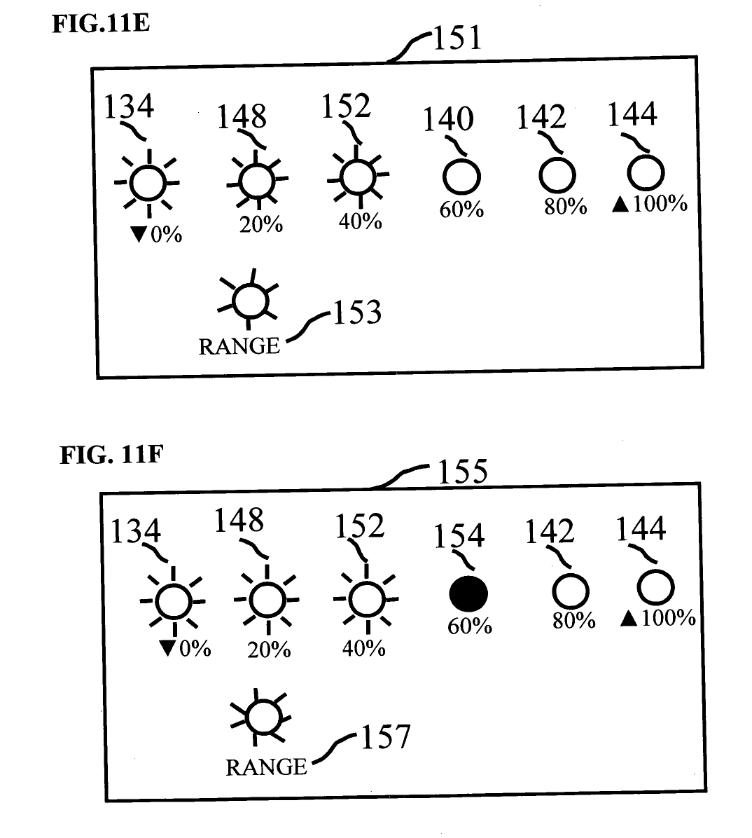

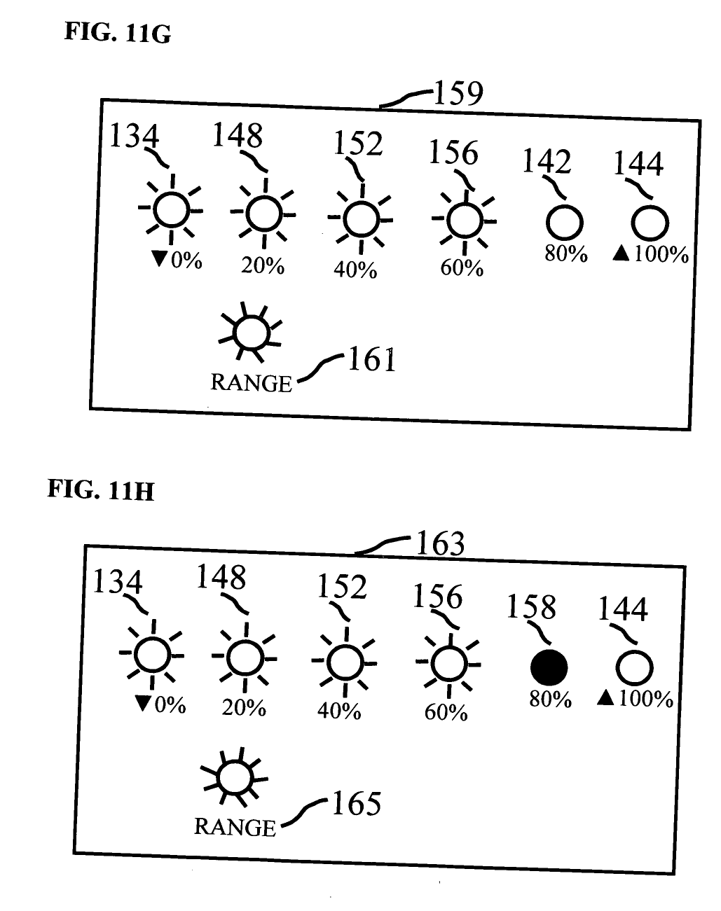

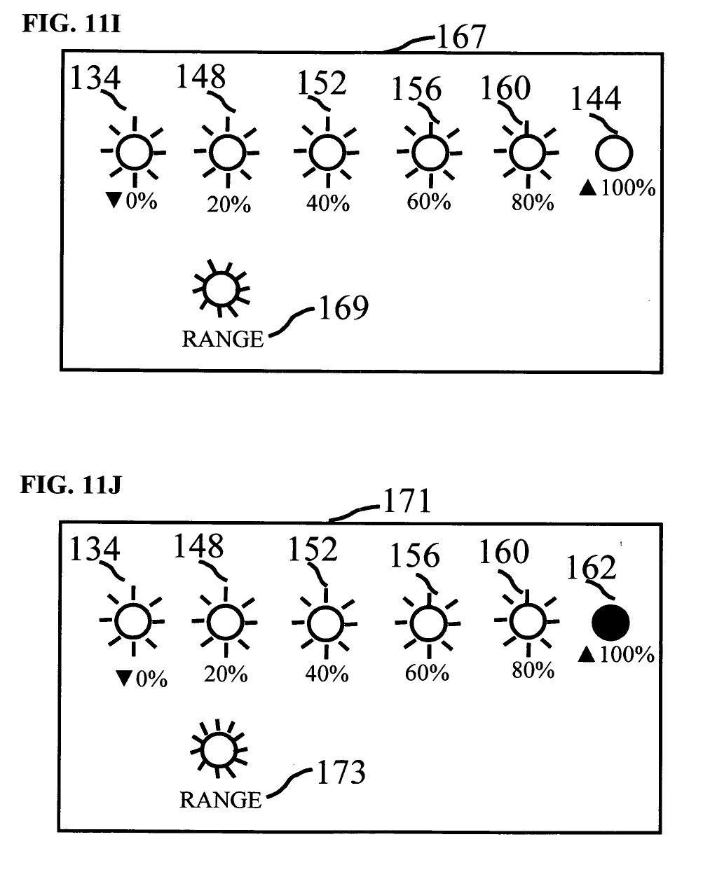

The simulation device 26 has two operating modes: dynamic mode and static mode. Now refer to FIG. 9B. When a device is operated in a static mode 131, it keeps the simulated signals at the set point until the mode is changed, or the simulation signals are changed by a remote terminal 30 or an operation of human machine interface component 6 (such as pushing the increase button 125 (FIG. 10A) on the simulation device 26). FIG. 9A depicts the dynamic mode 129. When operating in this mode, the simulation device 26 will increase the simulation signals values step by step from the theoretical minimum 109 (defined in the corresponding industrial CAN protocols) through intermediate levels 130 to the theoretical maximum 111 (defined in the corresponding industrial CAN protocols), followed by decreasing the values step by step from that maximum 111 to intermediate levels 130, then decreasing the values step by step to the minimum 109. The device repeats the course of 122, 124, 126, 128, 122, 124, 126, 128 . . . until the operating mode is changed. The number of steps between the minimum value and maximum value can be changed by the simulation software for different applications. It can be 100 steps, 1000 steps, 7 steps, 55 steps or any other number that makes sense to the application and useful for the end user. In various embodiments, the steps can be represented as the percentile values of the whole range between the minimum and the maximum value allowed. For example, FIG. 5A, FIG. 7, FIG. 8 and FIG. 11A-J show simulation steps represented by percentile values between 0% and 100%. In various embodiments, the steps can be represented by letters, words, phrases, sentences, symbols, etc and combinations of them. For example, one can name three simulation steps as Alpha-10 (α-10), Beta-50 (β-50) and Gamma-95 (γ-95). On the other hand, the gaps between any two adjacent steps within the range can be different. For example, the gap between step 2 and step 3 can be defined three times as large as that between step 50 and step 51, likely for the reason that step 2 and step 3's simulation signals are less important to the end user than signals at step 50 and step 51 where the impact of changing simulation signals is more significant to the end user.

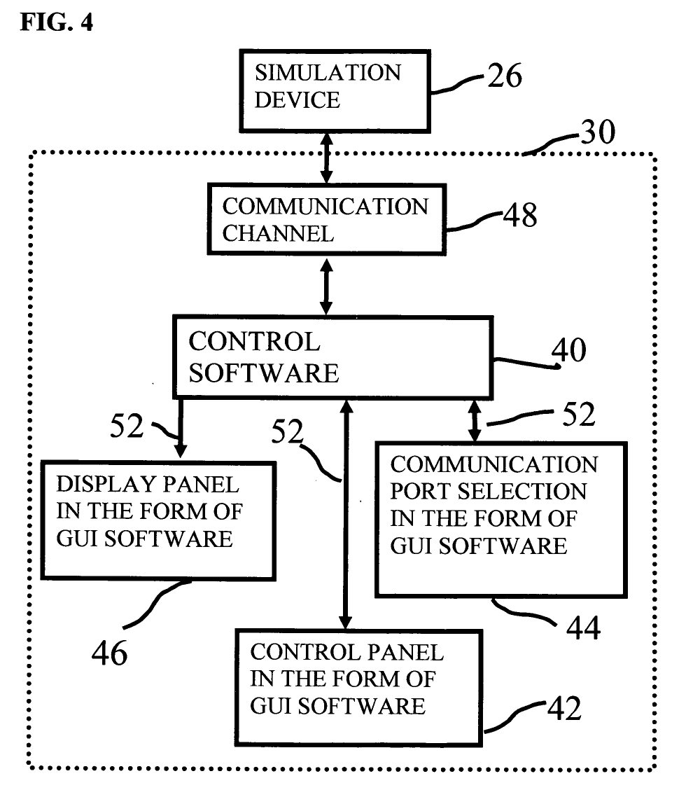

FIG. 4 is a block diagram representing the method of remote terminal 30 with software 40 and showing that such a terminal 30 is connected with a simulation signal generating device 26 through the communicating channel 48. The remote terminal comprises of a control panel 42, a display panel 46, and a communication port selection panel 44 in the form of graphic user interface (GUI) software. The control software 40 unites the control panel 42, the display panel 46, and the communication port selection panel 44 by several control logic 52 to work with a CAN protocol or multiple CAN protocols as defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

A remote terminal 30 is not required to operate a simulation device 26. For the convenience of use, there are operating switches/buttons on the simulation device. In one of the embodiments, as shown in FIG. 10A, there is a MENU button 132 to access mode control and other functions; an UP button 125 and a DOWN button 127 for quickly changing the simulation signals values.

FIG. 5A depicts a graphic user interface of the control panel 42 of a remote terminal 30. One can press the UP button 56 once at a time for signals to increase one-step-at-a-time; one can press the DOWN button 54 once at a time for signals to decrease one-step-at-a-time; one can get signals increase multi-steps-at-a-time by dragging the cursor 58 toward the maximum value direction along the scale bar 66; one can get signals decrease multi-steps-at-a-time by dragging the cursor 58 toward the minimum value direction along the scale bar 66. One can make the signal automatic increase and the signal automatic decrease by selecting the DYNAMIC mode 68. The control panel also has a function of mode selection. If the DYNAMIC 68 is selected, the simulation device will operate in the dynamic mode 129. If the DYNAMIC 68 is not selected, the simulation device will operate in the static mode 131. When the QUIET function 60 is selected, the remote terminal 30 will mute the audible signals. When the WARNINGS function 64 is selected, the remote terminal 30 will enable the warning functions on the simulation device 26. When the MENU button 70 is pressed, its assigned functions (such as turning on or off warning lamps) will be activated. At any time, the user can reset the Engine Diagnostic Message 2 (ENG DM2) by selecting the function of RESET ENG DM2 62.

In various embodiments, the control panel 42 may include more or less control functions than what are depicted in FIG. 5A.

FIG. 5B depicts a graphic user interface of the display panel 46 of a remote terminal 30. Warning signal lamps are displayed if there are any warning signals. If the CAN address is claimed successfully on CAN network 28, the panel will show “NORMAL”, as shown in status bars 76, 80, and 84. The display panel 46 can have sub-group panels, such as a status display 75, and a display 86 for detailed simulation values. The status display 75 includes various simulation signals status. For example, the engine status signals (such as cruise lamp status) simulation information and warning lamps information (if any) 74, the antilock brake system signals simulation information and warning lamps information (if any) 78, and the transmission signals simulation and warning lamp information (if any) 82 can be displayed in the FIG. 5B illustration. Multi-packets parameters 85 can be displayed for various signals on a new page when this button is chosen. In various embodiments, the display panel 46 and the control panel 42 can be expandable at the same time to multiple personal computers, laptops, network computers, or PDAs (Personal Digital Assistant), cell phones, and other capable electronic devices with appropriate interface or combination of above mentioned devices. In various embodiments, the display panel 46 may include more or less display functions than what are depicted in FIG. 5B.

FIG. 5C depicts a graphic user interface of the communication port selection panel 44 of a remote terminal. In one of the various embodiments, the communication port selection can be made with a pull down menu 88. In various embodiments, the communication port selection pull down menu 88 includes but is not limited to serial ports (COM1, COM2, COM3, . . . COM9, etc), Ethernet ports, I2C channels, USB ports, parallel ports, infrared ports, WiFi channels, etc. The button CONNECT 90 is for connecting the remote terminal 30 with the simulation device 26. The button DISCONNECT 92 is for disconnecting the remote terminal 30 with the simulation device 26. The EXIT button 94 will terminate the remote terminal software 30. In one embodiment as shown in FIG. 5C, the communication port selection panel 44 can also be used for the information-displaying purpose. For example, the product serial number 96 of the simulation device 26, the product identification 98, and the software version 100 of the simulation device 26 are displayed. In various embodiments of the remote terminal 30, the control panel 42, the display panel 46, and the communication port selection panel 44 can be on the same screen page or different screen pages. In various embodiments, the communication port selection panel 44 may include more or less communication port selection functions than what are depicted in FIG. 5C.

The remote terminal 30 and software can be installed and operated on a laptop, or a network computer, or a standalone computer, or a PDA (Personal Digital Assistant), or a cell phone or any other capable electronics device with appropriate interface.

The display panel 46 can be represented by one or multiple screen pages and a user is able to swap the pages; Likewise, the control panel 42 can be represented by one or multiple screen pages and a user is able to swap the pages; likewise, the communication port selection panel 44 can be represented by one or multiple screen pages and a user is able to swap the pages.

Another important aspect of this invention is the license identification management method. It is an advantageous method to easily change the functionality and features of a simulation device without any hardware modifications and without sending the device back to the device manufacturer or a service center.

For a simulation device 26 of this invention, a license identification 14 is assigned based on function requirements for this simulation device. The license identification 14 is readable by the device itself 26 at any time. If the device 26 is connected with a remote terminal 30, the license identification 14 can be shown to the user as a product ID 98.

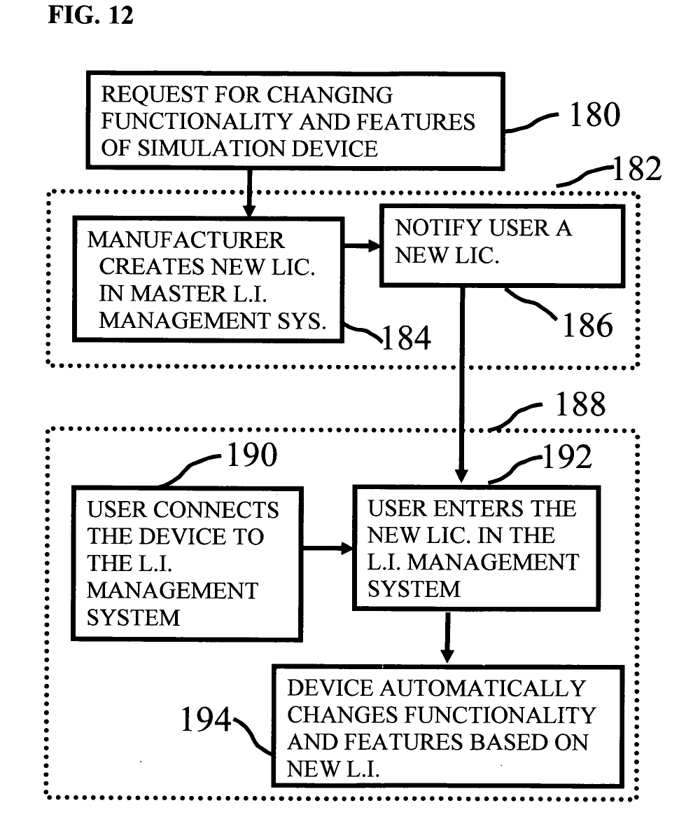

There is a master license management system 182. As shown in FIG. 12, upon a request 180 of changing functionality and features of a simulation device, license identifications are modified by the manufacturer's master license management system, as shown as the step 184. This step occurs at the manufacturer's end. In one of various embodiments, the license identification creation and modification processes are encrypted. The processes can also be non-encrypted. The manufacturer informs the user (via email, mail, phone or other acceptable communicating methods between the manufacturer and the end user) a new license of the end user's purchased simulating device, as shown as step 186.

There is an end user's license management system 188 which is in the form of graphic user interface software. Refer to FIG. 12. It reads the license identification of a simulation device. To change the device functions, the end user purchases and obtains a new license from the manufacturer (the step of 186), then connects the simulation device to the end user's license identification management system (the step of 190). After entering the new authorized license in the license identification management system (the step of 192) and updating the license identification, the new license identification will enable the device's new functions and features (the step of 194).

Inside this license identification management method and software, there is one or more established license identification hierarchies. In various embodiments, the identification hierarchy levels are represented by device identifications or device license or product identification 98: the higher the hierarchy level, the higher level of the license identification, the more powerful or wider range of functionality and features of the simulation device.

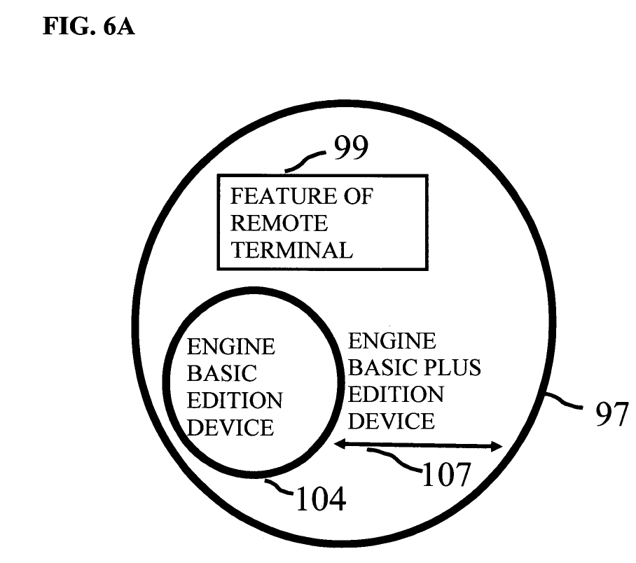

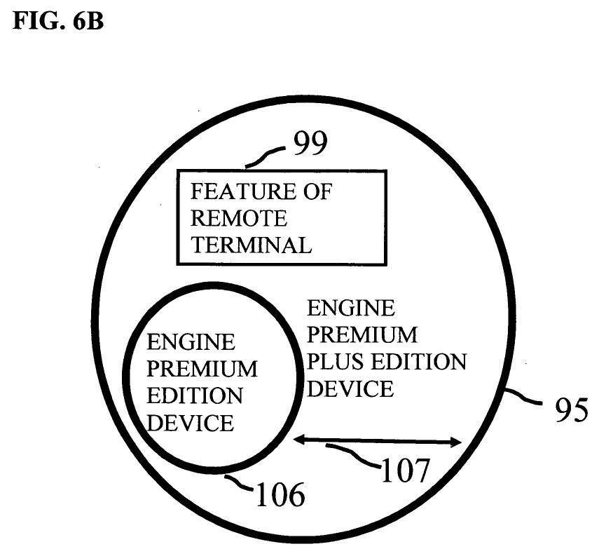

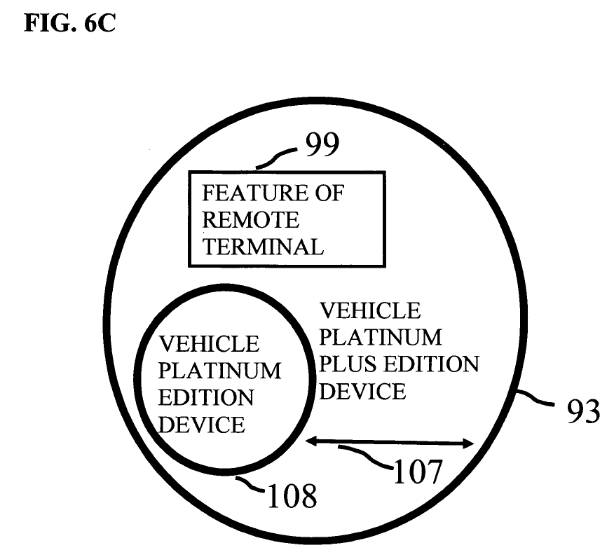

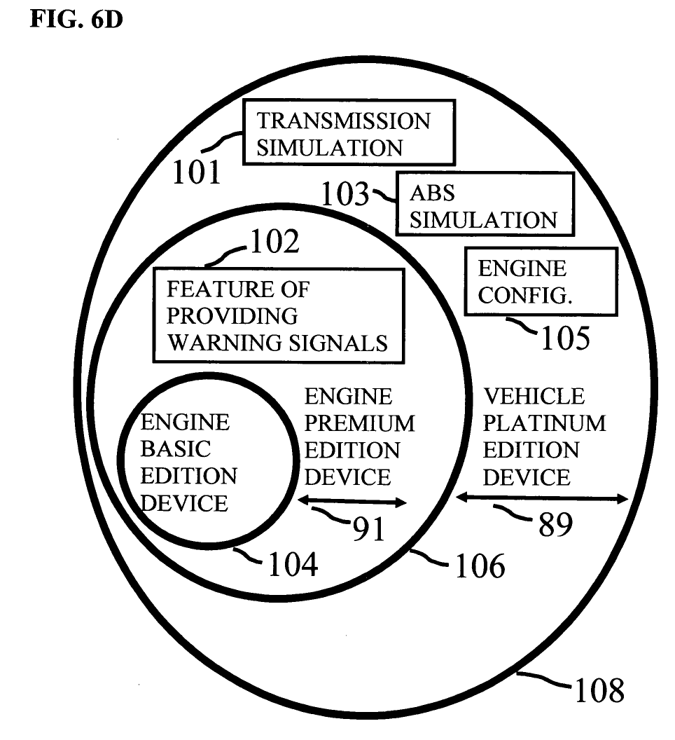

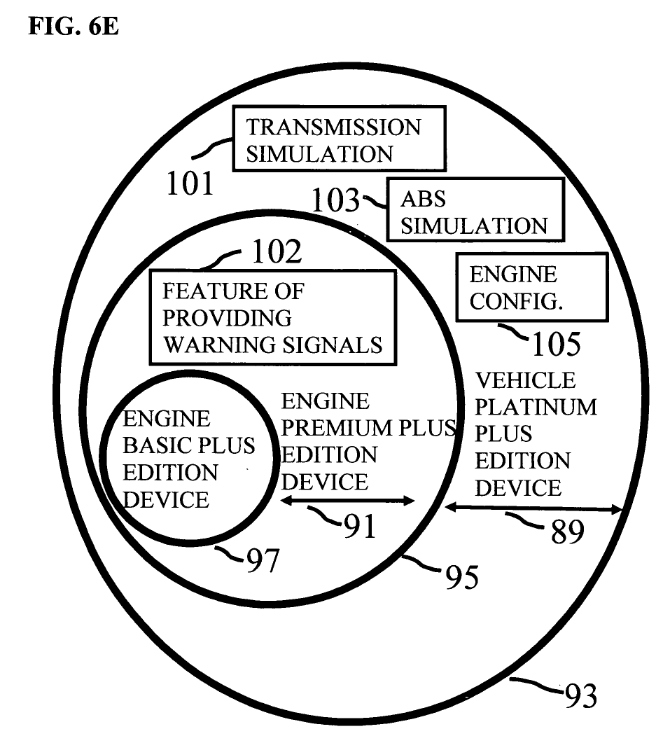

FIG. 6A to FIG. 6E illustrates how the license identification management system method is used. For example, in FIG. 6A, there is an engine basic edition simulation device 104. This device has no remote terminal feature according to the device's original license identification. By the process 107 of obtaining a new license (moving to a different hierarchy level of license identification), one can expect that the same device will be equipped with the feature of remote terminal 99. Therefore, it becomes an engine basic PLUS edition of simulation device 97. Likewise, as shown in FIG. 6B, an engine premium edition of simulation device 106, is upgraded to an engine premium PLUS edition of simulation device 95 by the process 107 of obtaining a higher hierarchy license. The new feature is a remote terminal 99. Likewise, as shown in FIG. 6C, a vehicle platinum edition of simulation device 108 is upgraded to a vehicle platinum PLUS edition 93 by the process of 107. The device will have the new feature of remote terminal 99 after updating the license identification.

The devices in FIG. 6A to FIG. 6C share the same hierarchy-changing structure in that a “PLUS” device includes the feature of the “remote terminal” 99. The hierarchy-changing is embedded in the process of 107. In the license identification management system, more than one hierarchy-changing possibility may exist. There may exist more than one license identification hierarchies in the license identification management method. And a simulation device is allowed for more than one function-change paths following different license identification hierarchies. For example, the engine BASIC edition device 104 can be upgraded to an engine PREMIUM edition device 106 with the added feature of providing warning signals 102, by the process of 91. This is depicted in FIG. 6D. We can also find another hierarchy-changing possibility in the process of 89 in that if a transmission simulation 101 feature, an antilock brake simulation 103 feature, and an engine configuration simulation 105 feature are added to an ENGINE simulation PREMIUM device, the new device becomes a VEHICLE platinum edition device 108. The same process of 89 is depicted in both FIG. 6D and FIG. 6E, with different starting simulation devices 104 and 97, respectively.

In the simulation software 22, there are both linear and non linear algorithms to generate the simulation signals for various CAN applications. FIG. 7 illustrates multiple linear algorithms 112 between simulation steps 116 and simulation values 114 while FIG. 8 includes non linear algorithm, such as 118 and 119. In both figures, CAN simulation signals are generated over a range between a theoretical minimum 109 and a theoretical maximum 111. These minimums and maximums of various CAN signals are defined in industrial CAN protocols. For example, the SAE J1939 standard has a definition of a road surface temperature data range, which is from the minimum of −273° C. to the maximum of 1735° C. In reality, an end user is less likely in great need of the extreme temperature data; rather he or she often needs data in the mostly-used-range. In practical use, the mostly-used-range 117 between P.MIN 113 and P.MAX 115 is usually smaller than the range between the theoretical minimum 109 and maximum 111.

In order to provide useful simulation signals, this invention introduces practical-use minimum P.MIN 113 and practical-use maximum P.MAX 115 for each simulation signal. Furthermore, the algorithm in this invention allows multiple simulation functions. For example, as depicted in FIG. 7, within the practical range 117 between 113 and 115, simulation values 114 are generated by three linear functions 112. The first linear function is defined between P.MIN (113) and P.S1, the second one is defined between P.S1 and P.S2, and the third one is defined between P.S2 and P.MAX (115).

In FIG. 8, several non linear functions, such as 118 and 119, exist for simulating signals. Furthermore, the invention allows both linear simulation functions and non linear simulation functions exist for any particular CAN signal. This is shown in FIG. 8 where linear functions 112 coexist with non linear functions 118 and 119.

In order to have the access to the simulated signal values without a remote terminal 30, the simulation device 26 has the feature to display the values of the simulated signals. In one of the various embodiments, FIG. 11A-J represents different simulating signal levels by the combination condition of a series of LEDs or similar visual components. In one of various embodiments, there are seven LEDs in FIG. 11A-J. Six LEDs are labeled as 0%, 20%, 40%, 60%, 80%, and 100%, respectively. The 0% designated LED also blinks when a signal decreasing operation is in process by pressing the DOWN button 127; the 100% designated LED also blinks when a signal increasing operation is in process by pressing the UP button 125. The seventh LED, labeled as “RANGE”, emits in a variable light intensity based on the simulated signal values. The higher the signal value, the brighter this “RANGE” LED will become. As the simulated signals values become higher and higher from FIG. 11A to FIG. 11J, the “RANGE” LED becomes brighter and brighter, shown by the brightness gradual increase from 137 to 145, 146, 149, 153, 157, 161, 165, 169, finally reaching the highest brightness of 173. Some possible combinations of six LED lights are interpreted as follows.

FIG. 11A shows a blinking 0% LED 133, an off 20% LED 139, an off 40% LED 138, an off 60% LED 140, an off 80% LED 142, and an off 100% LED 144; this combination represents the status of the minimal value of simulation signals. The RANGE LED emits in a very dim way as shown by 137.

FIG. 11B shows a constant lit 0% LED 134, a blinking 20% LED 136, an off 40% LED 138, an off 60% LED 140, an off 80% LED 142, and an off 100% LED 144; this combination represents the simulation signals are at the exact 20% level. The RANGE LED 145 gets brighter than 137.

FIG. 11C shows a constant lit 0% LED 134, a constant lit 20% LED 148, an off 40% LED 138, an off 60% LED 140, an off 80% LED 142, and an off 100% LED 144; this combination represents the simulation signals are between 20% and 40% level. The RANGE LED 146 gets brighter than 145.

FIG. 11D shows a constant lit 0% LED 134, a constant lit 20% LED 148, a blinking 40% LED 150, an off 60% LED 140, an off 80% LED 142, and an off 100% LED 144; this combination represents the simulation signals are at the exact 40% level. The RANGE LED 149 gets brighter than 146.

FIG. 11E shows a constant lit 0% LED 134, a constant lit 20% LED 148, a constant lit 40% LED 152, an off 60% LED 140, an off 80% LED 142, and an off 100% LED 144; this combination represents the simulation signals are between 40% and 60% level. The RANGE LED 153 gets brighter than 149.

FIG. 11F shows a constant lit 0% LED 134, a constant lit 20% LED 148, a constant lit 40% LED 152, a blinking 60% LED 154, an off 80% LED 142, and an off 100% LED 144; this combination represents the simulation signals are at the exact 60% level. The RANGE LED 157 gets brighter than 153.

FIG. 11G shows a constant lit 0% LED 134, a constant lit 20% LED 148, a constant lit 40% LED 152, a constant lit 60% LED 156, an off 80% LED 142, and an off 100% LED 144; this combination represents the simulation signals are between 60% and 80% level. The RANGE LED 161 gets brighter than 157.

FIG. 11H shows a constant lit 0% LED 134, a constant lit 20% LED 148, a constant lit 40% LED 152, a constant lit 60% LED 156, a blinking 80% LED 158, and an off 100% LED 144; this combination represents the simulation signals are at the exact 80% level. The RANGE LED 165 gets brighter than 161.

FIG. 11I shows a constant lit 0% LED 134, a constant lit 20% LED 148, a constant lit 40% LED 152, a constant lit 60% LED 156, a constant lit 80% LED 160, and an off 100% LED 144; this combination represents the simulation signals are between 80% and 100% level. The RANGE LED 169 gets brighter than 165.

FIG. 11J shows a constant lit 0% LED 134, a constant lit 20% LED 148, a constant lit 40% LED 152, a constant lit 60% LED 156, a constant lit 80% LED 160, and a blinking 100% LED 162; this combination represents the simulation signals are at the exact 100% level. The RANGE LED 173 gets brighter than 169.

The simulation device 26 can be accompanied with various software toolsets. In one of various embodiments, such as a simulation device designed according to the SAE-J1939 protocol, depicted in FIG. 10C, the additional toolsets 202 provided with the simulation device 26 can include a remote terminal software 196, a license management toolset 198, and a bootloader toolset 200 (a software for bootloading process control). Such software toolsets can be placed on a CD, attached in an email or other electronically stored formats, or partially embedded in the said simulation device, etc.

The foregoing discussion discloses and describes merely exemplary embodiments of the present invention. One skilled in the art will readily recognize from such discussion and from the accompanying drawing and claims that various changes, modifications and variations can be made therein without departing from the spirit and scope of the invention as defined in the following claims.

1. A self-maintaining simulation signal generating device for Controller Area Network (CAN), comprising:
microprocessor(s) or microcontroller(s) or field-programmable gate array(s) (FPGAs) or application-specific integrated circuit(s) (ASICs) or complex programmable logic device (s) (CPLDs), etc;
memory medium coupled to the microprocessor or microcontroller, FPGAs, ASICs, CPLDs, etc, wherein the memory comprises non-volatile memory (an EEPROM, a flash memory, a battery-backed RAM, etc) and wherein the memory medium stores initialization instructions and executable codes;
input and output (I/O), including but not limited to RS232 transceivers, USB transceivers, RS485 transceivers, SAE J1708 transceivers, etc;
one or more Controller Area Network interface(s) including but not limited to CAN transceivers (J1939 transceivers, NMEA 2000 transceivers, single wire CAN transceivers, etc), common mode choke(s), transient voltage suppressors (TVS), CAN network terminal resistors and signal isolation circuits (such as opto-isolators), etc;
some algorithms of defining and generating Controller Area Network simulating-signals wherein for any particular Controller Area Network signal the algorithm defines the simulation algorithm according to the practical usage conditions in multiple segments over the full range, and over the full range, or partially over the full range of Controller Area Network signal wherein the said signal full range is defined by a CAN protocol or multiple CAN protocols of the following, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.
simulation software embedded in the memory medium, executing the signal generating algorithm, executing I/O control algorithm for the simulating signals, controlling the simulating process and signals, communicating with remote terminal, generating and resetting warning messages, managing the device license identification system;
a license identification of the device, wherein the said license identification controls the functionality and features of the device in this invention;
oscillator circuits generating clock signals for microcontroller and peripheral devices;
a power regulator converting an unregulated power supply to a regulated power supply with stable voltage;
a human machine interface (HMI) including but not limited to operating switches, LEDs, lamps, other audible or visible signal components;
an enclosure wherein the said enclosure is compliable to NMEA (National Marine Electronics Association) environment standard or it may not be compliable;
an in-field bootloading feature which enables the reloading process of initialization instructions and executable codes to the said device without opening the enclosure and without sending the said device back to a device service center or the manufacturer.
elements of easily changing functionality and features of the said simulation device;
software toolsets that facilitate installations and operations of the said simulation device wherein the toolsets can be placed on a CD, in an email attachment or other electronically stored formats, or partially embedded in the said simulation device, etc.

2. The device of claim 1, the said human machine interface (HMI) is expandable to external one or multiple HMI (HMI), such as a display terminal for the parameters, or multiple display terminals for the parameters.

3. The device of claim 1, wherein when it is powered on, the said simulation signal generating device is automatically registered to the Controller Area Network; wherein when it is powered on, the said simulation signal generating device automatically goes to the same operating mode as last time it is powered off; wherein when it is powered on, the said device retrieves all of the simulating signals at the levels last time when the said simulation generating device is powered off.

4. The device of claim 1, wherein the simulation signals' values are modified through an operating switch or multiple operating switches by the user per the predetermined operating switch combinations in the control software of the said simulation signal generating device.

5. The device of claim 1, wherein the said simulation signal generating device has a static mode and a dynamic mode for CAN parameters simulation; wherein a user can alternate the operating mode between the static mode and the dynamic mode, wherein
a static mode comprising Controller Area Network simulation signals staying steady at a set level within the minimum and maximum of the signals' ranges, wherein the CAN parameters and their full ranges are defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc;
a dynamic mode comprising Controller Area Network simulation signals automatically changing step by step within the minimum and maximum of the signals' ranges; wherein upon reaching the minimum value of the range, the signals automatically turn around and then increase step by step; wherein upon reaching the maximum value of scale, the signals automatically turn around and decrease step by step from the maximum value; wherein the number of steps between the minimum value and maximum value can be changed; wherein the steps can be represented by percentile values, numbers, letters, phrases, sentences, symbols, etc and combination or them; wherein the gaps between any two adjacent steps within the range can be different; wherein the parameters and their full ranges are defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

6. A remote terminal method and software for CAN signals simulation, wherein the said remote terminal method and software comprising
a control panel in the form of graphic user interface (GUI) software wherein the signal simulation process can be made for signals increase one-step-at-a-time, decrease one-step-at-a-time, increase multi-steps-at-a-time, decrease multi-steps-at-a-time; automatic increase, automatic decrease; wherein other simulation process control functions include but not limited to: switching simulation modes between static mode and dynamic mode; mode status display control, turning on visible signals, turning off visible signals, turning on audible signals, turning off audible signals, turning on certain warning signals, turning off certain warning signals, turning on all warning signals, and turning off all of the warning signals;
a display panel in the form of graphic user interface (GUI) software wherein the product name, version, serial number, etc of a device are displayed, the simulated signals' actual values are displayed, warning signals and warning lamps are displayed, simulation mode is displayed, operational instructions are displayed; wherein multi-packets parameters are displayed for various signals;
a communication port selection panel in the form of graphic user interface (GUI) software wherein communication ports are designed and displayed to choose; wherein communication ports include but are not limited to serial ports (COM1, COM2, COM3, . . . COM9, etc), Ethernet ports, I2C channels, USB ports, parallel ports, infrared ports, WiFi channels, etc; wherein the selected port information is displayed; wherein the connecting and disconnecting functions are designed and displayed to choose;
a control software wherein the said control panel, display panel, and communication port selection panel are united by several control logic to work with a CAN protocol or multiple CAN protocols as defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUSp, MilCAN, CANaerospace, Smart Distributed System, and ARINC 825, etc.

7. The method and software of claim 6, wherein the remote terminal can be installed and operated on a laptop, or a network computer, or a standalone computer, or a PDA (Personal Digital Assistant), or a cell phone or any other capable electronic device with appropriate interface.

8. The remote terminal of claim 6, wherein part or all of the display panel, the control panel and the communication port selection panel are expandable to multiple personal computers, laptops, network computers, or PDAs (Personal Digital Assistant), cell phones, and other capable electronic devices with appropriate interface or combination of above mentioned devices at the same time.

9. The remote terminal of claim 6, wherein the said display panel is represented by one or multiple screen pages and a user is able to switch the pages; wherein the said control panel is represented by one or multiple screen pages and a user is able to switch the pages; wherein the said communication port selection panel is represented by one or multiple screen pages and a user is able to switch the pages.

10. The remote terminal of claim 6, wherein the said control panel, the said display panel, and the said communication port selection panel are on the same screen page or partially mixed on some pages, or spread over different screen pages.

11. A method of controlling and changing the functionality and features of a signal simulating device for Controller Area Network applications comprising
a license identification wherein a particular license identification is assigned to each signal simulation device based on requirements for simulating device functionality and features; wherein the said license identification is readable by the device itself at any time;
a master license identification management system (typically at the manufacturer's end) wherein a new license identification for any particular edition of the simulating device can be created by the manufacturer's master management system; wherein the license identification of a simulation device can be read by the master license identification management system when the said simulation device is connected to the master license identification management system; wherein the manufacturer informs (via email, mail, phone or other acceptable communicating methods between manufacturer and end user) the new license (which represents the new license identification) of the end user's purchased simulating device; wherein upon a request for a change of functions of simulating device, the manufacturer overwrites the old license for that particular simulating device followed by generating a new license in the master management system, followed by the manufacturer informing the end user about the new license; wherein the new license represents a new license identification for the simulation device;
a license identification management system in user's edition, wherein it is generally provided for the end user of the simulation device, wherein the license identification is governed by the said license management system, and the license identification of the said simulating device is readable by the license management system when the simulation device is connected to the license management system; wherein the change of device functions is completed through the end user purchasing and obtaining a new license from the manufacturer, then connecting the simulating device to the end user's license identification management system, entering the new authorized license in the license identification management system and updating the license; wherein the new license represents a new license identification for the simulation device;
One or more established license identification hierarchies based on the simulating device functions; wherein the identification hierarchy levels are represented by device identifications or device license or product identification, wherein the higher the hierarchy level, the higher level of the license identification, the more powerful or wider range of functionality and features of the simulation device.

12. The method of claim 11, wherein the level of functionality of a simulating device is expanded/upgraded via changing the device's license and license identification to a different hierarchy level by the license identification management system; wherein the level of functionality of a simulating device is downgraded via changing the device's license and license identification to a different hierarchy level by the license identification management system; wherein there may exist more than one license identification hierarchies in the said method; wherein a simulation device is allowed for more than one function-change paths following different license identification hierarchies; wherein an upgrading or a downgrading or some other device function change process is accomplished without opening the enclosure of the said device, without any hardware changes, without the need of sending the said device to the manufacturer.

13. The method of claim 11, wherein the generating, changing, reading and other operations of the licenses and license identifications, are encrypted.

14. The device of claim 1, wherein the said simulation device is equipped with bootloading feature that is used for loading the initialization instructions and executable codes of the said simulation device without opening the enclosure of the said device, without any hardware changes, without the need of sending the said device back to the manufacturer, wherein the loading of initialization instructions and executable codes to the said simulation device is complying the following communication protocols, but not limited to: RS232, USB, CAN protocols, RS485, SAE J1708, SAE J1939, NMEA 2000, etc; wherein bootloading function can be enabled by the human machine interface of the simulation device; wherein after entering the bootloading mode, the simulation device will automatically detect any pre-defined bootloading handshaking protocols; wherein if it does not detect any bootloading handshaking protocols within a reasonable pre-set time, the simulation device will automatically exit the bootloading mode.

15. The bootloading process of claim 14, wherein the process for the said bootloading can be encrypted.

16. The device of claim 1, wherein the said simulation algorithm comprising linear algorithms between the simulation signals' values and the control values (simulation steps) over certain partial segments of full ranges or over the full ranges of the parameters wherein the parameters and their full ranges are defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

17. The device of claim 1, wherein the said simulation algorithm comprising non-linear algorithms between the simulation signals' values and the control values (simulation steps) over certain partial segments of full ranges or over the full ranges of the parameters wherein the parameters and their full ranges are defined by, but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

18. The device of claim 1, wherein the said signal generating device produces signals for one or multiple CAN controller applications (CA), such as the engine electronic control unit (ECU), transmission ECU, antilock braking system (ABS) ECU, air bag ECU and other systems equipped with ECUs that communicate via Controller Area Network protocols, including but not limited to: SAE J1939, SAE J1939-01, SAE J1939-11, SAE J1939-13, SAE J1939-15, SAE J1939-21, SAE J1939-31, SAE J1939-71, SAE J1939-73, SAE J1939-74, SAE J1939-75, SAE J1939-81, SAE J2411, NMEA 2000 (National Marine Electronics Association 2000), ISO 11898-1, ISO 11898-2, ISO 11898-3, ISO 11898-4, ISO 11898-5, ISO 11992-1, ISO 11783-2, DeviceNet, CANopen, CAN Kingdom, SafetyBUS p, MilCAN, CANaerospace, Smart Distributed System, and ARINC 825, etc.

19. The said device of claim 1, wherein the device size and enclosure configuration can be made to fit onto a palm of an average adult human being; wherein the device can be made appropriate to fit onto most of commonly used desktops, bench tops, etc. in various CAN application environments; wherein the device size, shape and configuration of the same or similar CAN signal simulation device can be changed and configured such that it can be placed at and transferred among various engineering testing environments, CAN network test laboratories, CAN application fields, etc.

20. The said device of claim 1, wherein the simulation signal output levels are displayed by the conditions of a series of LEDs, and/or light bulbs and/or other visual signals and/or the likes (LEDs and the-likes) on the said simulation device,
wherein a blinking 0% LED and the-like represents the status of the minimal value of simulation signals.
wherein a X₁%-designated blinking LED and the-like, and no higher-percentage designated LEDs and the-likes constant-lit or blinking, represent the status of a X₁% level of simulation signals;
wherein a constant lit X₁%-designated LED and the-like, and no higher-percentage designated LEDs and the-likes constant-lit or blinking, represent the status that the simulation signal level is between X₁% and the next level X₂%;
wherein a constant lit X₁%-designated LED and the-like, and a blinking X₂%-designated LED and the like represent the status of a X₂% level of simulation signals;
wherein a constant lit X₁%-designated LED and the-like, a constant lit X₂%-designated LED and the-like, and no other higher-percentage lit or blinking LEDs and the-likes represent the status that the simulation signal level is between X₂% and the next level X₃%;
wherein a constant lit X₁%-designated LED and the-like, a constant lit X₂%-designated LED and the-like, and a blinking X₃% LED and the-like represent the status of a X₃% level of simulation signals;
wherein a constant lit X₁%-designated LED and the-like, a constant lit X₂%-designated LED and the-like, a constant lit X₃%-designated LED and the-like, and no other higher-percentage lit or blinking LEDs and the-likes represent the status that the simulation signal level is between X₃% and the next level X₄%;
wherein a constant lit X₁%-designated LED and the-like, a constant lit X₂%-designated LED and the-like, a constant X₃%-designated LED and the-like, and a blinking X₄% LED and the-like represent the status of an X₄% level of simulation signals;
wherein a constant lit X₁%-designated LED and the-like, a constant lit X₂%-designated LED and the-like, a constant lit X₃%-designated LED and the-like, a constant lit X₄%-designated LED and the-like and no other higher-percentage lit or blinking LEDs and the-likes represent the status that the simulation signal level is between X₄% and the next level X₅%;
wherein, a constant lit X₁%-designated LED and the-like, a constant lit X₂%-designated LED and the-like, a constant X₃%-designated LED and the-like, a constant X₄%-designated LED and the-like, . . . a constant lit Xₙ₋₁ LED and the-like and a blinking Xₙ% LED and the-like represent the status of a Xₙ% level of simulation signals; wherein n is an integer greater than 0;
wherein, a constant lit X₁%-designated LED and the-like, a constant lit X₂%-designated LED and the-like, a constant lit X₃%-designated LED and the-like, a constant lit X₄%-designated LED and the-like, . . . a constant lit Xₙ% LED and the-like and no other higher-percentage lit or blinking LEDs and the-likes represent the status that the simulation signal level is between Xₙ% and the next level Xₙ₊₁%;
wherein, eventually, a constant lit X₁%-designated LED and the-like, a constant lit X₂%-designated LED and the-like, a constant lit X₃%-designated LED and the-like, a constant lit X₄%-designated LED and the-like, . . . a constant lit Xₙ% designated LED and the-like, . . . the constant lit status of all LEDs and the-likes with designations less than 100%, a blinking 100% designated LED and the-like represent the status that the simulation signal level is at 100% level of simulated signals;
wherein the above 0%, X₁%, . . . 100% designated values can be other arbitrary numbers, percentiles, or non-numerical values, . . . meaningful to the user;
wherein the brightness of the LED and the-like designated for the range and level of simulated signals represents a level or a range of the simulation signals; wherein the brighter this LED and the-like is lighted, the higher level of simulation signals the said simulation device produces; the dimmer this LED and the-like is lighted, the lower level of simulation signals the said simulation device produces.
